(19) United States
(12) Patent Application Publication
(10) Pub. No.: US 2016/0015073 A1
(43) Pub. Date: Jan. 21, 2016

(54) COFFEE CHERRY BEVERAGE COMPOSITIONS AND METHODS FOR THEIR PREPARATION

(71) Applicant: EMPIRE TECHNOLOGY DEVELOPMENT LLC, Wilmington, DE (US)

(72) Inventors: Daniel Alderic BELLIVEAU, Bellevue, WA (US); Scott Allen James MCMARTIN, Seattle, WA (US)

(21) Appl. No.: 14/774,084

(22) PCT Filed: Dec. 20, 2013
(86) PCT No.: PCT/US13/77161

§ 371 Date: Sep. 9, 2015

Related U.S. Application Data
(60) Provisional application No. 61/785,195, filed on Mar. 14, 2013.

(51) Int. Cl. A23L 2/39; A23L 2/56; A23L 2/38; A23L 1/212

(52) U.S. Cl. CPC A23L 2/39; A23L 1/2126; A23L 2/56; A23L 2/38; A23V 2002/00

(57) ABSTRACT

Beverage compositions having portions of coffee cherries are described, as well as methods of forming the beverage compositions. The beverage compositions may include at least one fluid and a solid composition admixed with the fluid. The solid composition may include a particulate composition having one or more portions of a dried deseeded coffee cherry. The particulate composition may have an average particle size of about 80 μm to about 3000 μm.

### CROSS-REFERENCE TO RELATED APPLICATIONS

This application claims the priority benefit of U.S. Provisional Patent Application No. 61/785,195, filed Mar. 14, 2013 and entitled “Flour Compositions and Food and Beverages Comprising Thereof”, which is incorporated herein by reference in its entirety.

### BACKGROUND

The domestic consumption of coffee has increased about 57.6% in coffee exporting countries between 2000 and 2011. In addition, the consumption of coffee in coffee importing countries has increased about 10.8% between 2000 and 2010. In total, world coffee production in 2011 used about 7.9 million tons of coffee beans.

To obtain the coffee beverage that is widely consumed throughout the world, coffee beans must be removed from coffee cherries and processed. There are two types of isolation processes (“coffee processing”) that are commonly used: dry processing and wet processing. Dry processing includes, after harvesting, drying the coffee cherries to about 10-11% moisture content. The coffee beans are separated from the material covering the beans (for example, the outer skin, pulp, parchment, and silverskin) using a de-hulling machine. Wet processing, on the other hand, does not require drying of the cherries. In a wet processing method, the outer skin and the pulp are mechanically removed and the beans are fermented to remove a layer of remaining pulp material thereon, which is about 0.5 mm to about 2 mm thick. After fermentation, the coffee beans are dried so they contain about 12% water by weight and dehulled to remove the parchment. The bean is the only material retained for sale or storage, with the remainder of the coffee cherries being discarded, used as organic compost, or burned as fuel. Thus, when the remainder is discarded, 50% of the total mass of the coffee cherry is discarded as byproduct material. Thus, to obtain every ton of coffee beans, a ton of byproduct material must be generated. With the ever-increasing consumption of coffee throughout the world, the amount of byproduct has rapidly increased.

In coffee producing countries, the coffee byproducts constitute a source of contamination and environmental concern. For example, the pulp and the mucilage are relatively acidic, corrosive to equipment, and difficult to safely dispose. Furthermore, the pulp and the mucilage can lower the pH of waterways, which could potentially be deleterious to fish and other aquatic life forms. Additionally, where the pulp is discarded in a landfill or other disposal site, rotting pulp will often generate significant odors over time. Accordingly, it may be desirable to reduce waste from coffee byproducts, particularly portions of the coffee cherry that are not used for typical coffee bean purposes, such as, for example, the pulp, the mucilage, the stem, and/or the hull.

Previous methods of reducing waste included processing the coffee byproducts for human consumption. However, these methods have been unsuccessful due to taste issues such as flavor, texture, and/or the like. These methods have also been unsuccessful due to an inability of the byproducts to mix with other ingredients to form food products, an inability to comply with human and/or other animal consumption safety requirements, and/or the like.

### SUMMARY

In an embodiment, a beverage composition may include at least one fluid and a solid composition admixed with the fluid. The solid composition may include a particulate composition having one or more portions of a dried coffee cherry. The dried coffee cherry can be a dried deseeded coffee cherry. The particulate composition may have an average particle size of about 80 μm to about 3000 μm.

In an embodiment, a method of forming a beverage composition may include providing at least one fluid and admixing a dry composition with the fluid. The dry composition may include a particulate composition having one or more portions of a dried coffee cherry. The dried coffee cherry can be a dried deseeded coffee cherry. The particulate composition may have an average particle size of about 80 μm to about 3000 μm.

### BRIEF DESCRIPTION OF THE DRAWINGS

FIG. 1 depicts a cross sectional view of a coffee cherry structure according to an embodiment.

FIG. 2 depicts a second cross sectional view of a coffee cherry structure according to an embodiment.

FIG. 3 depicts a flow diagram of a method of forming a food product according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

A “coffee cherry” generally refers to one whole fruit of the coffee tree, belonging to the genus Coffea. A coffee cherry includes various portions, as described herein, including a coffee bean (or “seed”), pulp, mucilage, a hull, a stem, and the like. Species of coffee trees that produce coffee cherries include, without limitation, Coffea arabica and Coffea canephora. Beans from coffee cherries produced by the Coffea arabica tree are generally referred to as “Arabica” beans, while beans from coffee cherries produced by the Coffea canephora are generally referred to as “Robusta” beans.

A “deseeded coffee cherry” is a coffee cherry that has had the bean portion (including the center cut and the endosperm) removed. Thus, a deseeded coffee cherry contains all of the portions of the coffee cherry except for the bean and its constituent parts. Portions of the deseeded coffee cherry will be discussed in greater detail herein, and generally include hull, mucilage, silverskin, a parchment coat, a pectin layer, pulp, outer skin, a stem, leaves, and the like. In some embodiments, the deseeded coffee cherry may only include certain portions of the coffee cherry and may exclude other portions in addition to the coffee bean. For example, in some embodiments, the deseeded coffee cherry may consist of the pulp, the mucilage, and/or the hull. In some embodiments, the deseeded coffee cherry can include the outer skin, pulp, and pectin layer.

A “particulate composition” includes one or more portions of a dried and deseeded coffee cherry, as described herein. A “solid composition” includes at least the particulate composition as described in greater detail herein. The solid composition may further include any number of additional ingredients, as described herein. A “dry composition” is a solid composition before a fluid is added to form a beverage composition, as described in greater detail herein. Thus, the terms “solid composition” and “dry composition” may be used interchangeably herein.

A “beverage composition” includes any drink that is in a liquid form or can be incorporated with a liquid or converted to a liquid prior to consumption. The beverage composition further can be consumed by drinking Illustrative examples of beverage compositions include a carbonated soft drink, a non-carbonated soft drink, a fountain beverage, a frozen beverage, a partially frozen beverage, a ready-to-drink beverage, a dairy beverage, a powdered soft drink, a liquid concentrate, a liquid extract, a liquid dessert, a nutritional supplement, a flavored water, an enhanced water, an energy drink, a sport drink, an alcoholic drink, and the like.

Components of deseeded coffee cherries possess many potentially beneficial substances if preserved in a non-degraded (non-fermented) state. For example, fresh pulp contains high levels of polyphenol antioxidants, and fresh mucilage contains complex polysaccharides and antioxidants. The hull also contains small amounts of polyphenols and thus could be used as an additional source for antioxidants. Therefore, better utilization of these byproducts of deseeded coffee cherries could make the cultivation and processing of coffee more economical.

The beverage compositions disclosed herein are generally directed to beverage compositions that incorporate at least a portion of the coffee cherry that would otherwise be discarded as byproduct material. These portion(s) of the coffee cherry may be combined with various other ingredients to produce beverage compositions that possess beneficial properties, are generally pleasant tasting, comply with food safety requirements, and/or can be produced for mass consumption.

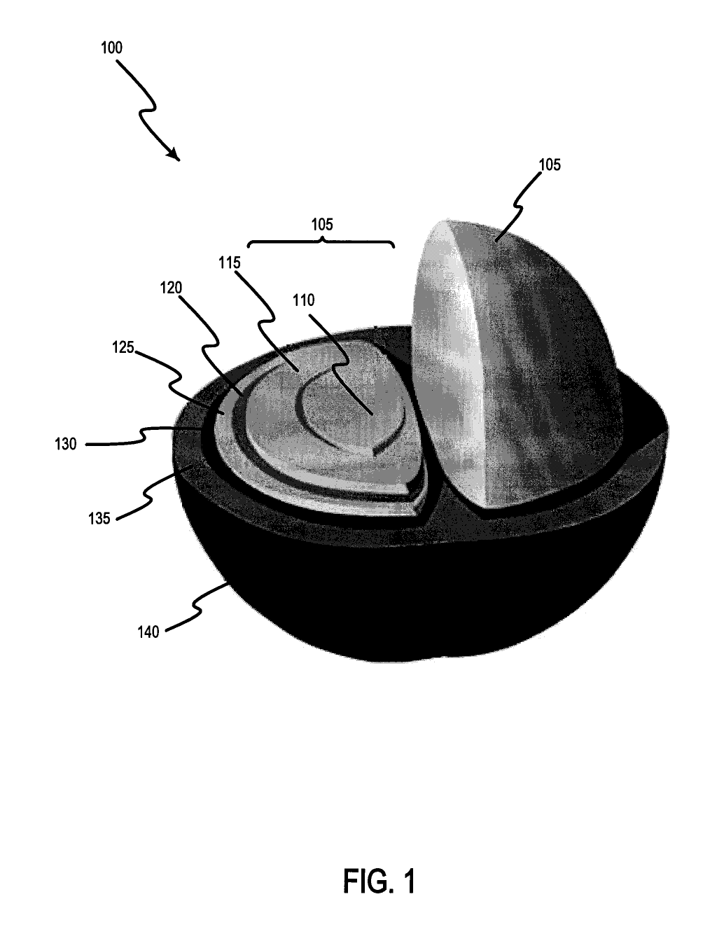

FIG. 1 depicts a cross sectional view of a coffee cherry, generally designated 100, according to an embodiment. The coffee cherry 100 generally includes the bean 105, which is the portion that is usually removed and processed for coffee beverages as described in greater detail herein. The bean 105 may generally include a center cut 110 and an endosperm 115. The center cut 110 is generally the innermost portion of the bean 105, and the endosperm 115 is generally a portion that acts as a food store because it contains a starch, protein, and other nutrients.

The remainder of the coffee cherry 100 may generally be referred to as a deseeded coffee cherry, and may contain, for example, a silverskin 120, a parchment coat 125, a pectin layer 130, a pulp 135, and an outer skin 140. In some embodiments, the deseeded coffee cherry can include the outer skin 140, pulp 135, and pectin layer 130. The silverskin 120 may also be referred to as the epidermis. The silverskin 120 is a thin tegument (covering) that is generally the innermost portion of the coffee cherry 105 that encapsulates the bean 105. The silverskin 120 is a major byproduct of the roasting process to produce roasted coffee beans, and may contain high levels of antioxidants. In general, the silverskin 120 may cling to the bean 105 even after the drying process, and may be removed via polishing or roasting the bean. When the silverskin 120 is removed from the bean 105 during the roasting process, it is typically referred to as chaff. The parchment coat 125, which may also be known as the endocarp or the hull, surrounds the silverskin 120 with a parchment-like covering. Surrounding the parchment coat 125 is the pectin layer 130, which is a mucus-like substance. The pectin layer 130 is surrounded by the pulp 135, which is also known as the mesocarp. The pulp 135 is a fibrous mucilagenous material that is fleshy in appearance and texture. The pulp 135 may include an amount of caffeine and tannins, thus making the pulp somewhat toxic, as described in greater detail herein. The pulp 135 may be processed to remove or reduce the level of toxins, as described in greater detail herein. The outer skin 140 is the outermost portion of the coffee cherry 100, which is generally a thick membrane that protects the various other contents of the coffee cherry. The outer skin 140 may sometimes be referred to as the exocarp. The coffee cherry 100 as used herein may also include other portions not specifically shown in FIG. 1, including a stem, leaves, and/or the like.

In various embodiments, one or more of the portions of the deseeded coffee cherry 100 may be processed to obtain a particulate composition for use as described herein. Processing may include, for example, separating the portions of the deseeded coffee cherry from the coffee bean via a wet processing or a dry processing method. In some embodiments, the various portions of the deseeded coffee cherry may be dried. In some embodiments, drying may be performed before deseeding. Drying may occur prior to the addition of a fluid as described in greater detail herein. In particular embodiments, the deseeded portions of the coffee cherry may be dried so that they contain a moisture content of about 0% by weight to about 20% by weight or about 2% by weight to about 12% by weight, including about 1% by weight, about 2% by weight, about 3% by weight, about 4% by weight, about 5% by weight, about 6% by weight, about 7% by weight, about 8% by weight, about 9% by weight, about 10% by weight, about 11% by weight, about 12% by weight, about 15% by weight, about 20% by weight, or any value or range between any two of these values (including endpoints).

Processing may further include, for example, grading and classifying the portions of the deseeded coffee cherry to remove any portions that may not be usable for the purposes described herein. Examples of grading and classifying may include, for example, removing undesirable portions, inspecting for color, inspecting for clumping, inspecting for moisture level, and inspecting for foreign materials.

Processing may also include grinding, milling and/or pre-milling the portions of the deseeded coffee cherry to obtain the particulate composition. Grinding may be performed by various grinding devices known to those having ordinary skill in the art, such as a hammer mill, a roller mill, a disk mill, or the like. The particulate compositions and/or portions thereof may be ground to various sizes, defined by a particle size (for instance, measured in microns), a mesh size, a surface area, or the like. In some embodiments, the particulate composition may have an average particle size of about 1 micrometer to about 5000 micrometers or about 80 micrometers to about 3000 micrometers. In particular embodiments, the particulate composition may have an average particle size of about 1 micrometer, about 10 micrometers, about 25 micrometers, about 40 micrometers, about 50 micrometers, about 80 micrometers, about 100 micrometers, about 120 micrometers, about 200 micrometers, about 400 micrometers, about 500 micrometers, about 1000 micrometers, about 2000 micrometers, about 3000 micrometers, about 4000 micrometers, about 5000 micrometers, or any value or range between two of these values (including endpoints). In some embodiments, the particulate composition may have a coarse average particle size for shipping and transport. The coarse average particle size may be about 2000 micrometers to about 5000 micrometers, including about 2000 micrometers, about 2500 micrometers, about 3000 micrometers, about 4000 micrometers, about 5000 micrometers, or any value or range between two of these values (including endpoints). In some embodiments, the particulate composition may be milled at a final processing destination to produce a fine average particle size. The fine average particle size may be about 1 micrometer to about 400 micrometers, including about 1 micrometer, about 10 micrometers, about 20 micrometers, about 25 micrometers, about 40 micrometers, about 50 micrometers, about 75 micrometers, about 80 micrometers, about 100 micrometers, about 120 micrometers, about 200 micrometers, about 300 micrometers, about 400 micrometers, or any value or range between two of these values (including endpoints). In some embodiments, the particulate composition may be ground so that about 10% to about 20% of the ground particulate composition is retained by a mesh having openings with a size of about 20 mesh and so that about 80% to about 90% of the ground particulate composition is retained by a mesh having openings with a size of about 230 mesh. The mesh sizes may be standardized according to Table 1 below:

TABLE 1
MESH TO MICRON CONVERSION CHART

| U.S. MESH | INCHES | MICROMETERS |
|---|---|---|
| 3 | 0.2650 | 6730 |
| 4 | 0.1870 | 4760 |
| 5 | 0.1570 | 4000 |
| 6 | 0.1320 | 3360 |
| 7 | 0.1110 | 2830 |
| 8 | 0.0937 | 2380 |
| 10 | 0.0787 | 2000 |
| 12 | 0.0661 | 1680 |
| 14 | 0.0555 | 1410 |
| 16 | 0.0469 | 1190 |
| 18 | 0.0394 | 1000 |
| 20 | 0.0331 | 841 |
| 25 | 0.0280 | 707 |
| 30 | 0.0232 | 595 |
| 35 | 0.0197 | 500 |
| 40 | 0.0165 | 400 |
| 45 | 0.0138 | 354 |
| 50 | 0.0117 | 297 |
| 60 | 0.0098 | 250 |
| 70 | 0.0083 | 210 |
| 80 | 0.0070 | 177 |
| 100 | 0.0059 | 149 |
| 120 | 0.0049 | 125 |
| 140 | 0.0041 | 105 |
| 170 | 0.0035 | 88 |
| 200 | 0.0029 | 74 |
| 230 | 0.0024 | 63 |
| 270 | 0.0021 | 53 |
| 325 | 0.0017 | 44 |
| 400 | 0.0015 | 37 |

Thus, the particulate composition may be ground to a particulate size that ranges from about 20 mesh to about 230 mesh, including about 20 mesh, about 25 mesh, about 30 mesh, about 35 mesh, about 40 mesh, about 45 mesh, about 50 mesh, about 60 mesh, about 70 mesh, about 80 mesh, about 100 mesh, about 120 mesh, about 140 mesh, about 170 mesh, about 200 mesh, about 230 mesh, or any value or range between two of these values (including endpoints). In some embodiments, the particulate compositions and/or various portions thereof may have a varying distribution of particle sizes based upon the ingredients. Thus, the varying mesh sizes of each ingredient may be independent of mesh sizes for other ingredients.

The coffee cherry and/or various portions thereof may naturally contain one or more toxins, including mycotoxins such as aflatoxins, fumonisins, ochratoxins, vomitoxins, and/or the like. Accordingly, processing may include reducing or removing toxins from the portions of the deseeded coffee cherry. Alternatively, processing may include removing or reducing toxins from the particulate composition. The reducing or removing of toxins may improve consumers' safety and/or to comply with various safety regulations such as, for example, the World Health Organization's (WHO) International Programme on Chemical Safety (IPCS) or the Scientific Committee on Food (SCF) of the European Union (EU). Thus, in some embodiments, the portions of the deseeded coffee cherry and/or the particulate composition may have an aflatoxin mycotoxin level of equal to or less than about 20 parts per billion (ppb) for total aflatoxins, a fumonisin mycotoxin level of equal to or less than about 2 micrograms (μg) per kilogram of body weight of a consumer for total fumonisins, an ochratoxin mycotoxin level of equal to or less than about 10 ppb for total ochratoxins, and/or a vomitoxin mycotoxin level of equal to or less than about 1 part per million (ppm) for vomitoxins. In particular embodiments, the portions of the deseeded coffee cherry and/or the particulate composition may have an aflatoxin mycotoxin level of about 20 ppb, about 15 ppb, about 10 ppb, about 5 ppb, about 1 ppb, about 0.5 ppb, about 0.1 ppb, about 0.05 ppb, about 0 ppb, or any value or range between two of these values (including endpoints). In particular embodiments, the portions of the deseeded coffee cherry and/or the particulate composition may have a fumonisin mycotoxin level of, per kilogram of body weight of a consumer, about 2 μg, about 1 μg, about 0.5 μg, about 0.1 μg, about 0.05 μg, about 0 μg, or any value or range between two of these values (including endpoints). In particular embodiments, the portions of the deseeded coffee cherry and/or the particulate composition may have an ochratoxin mycotoxin level of about 10 ppb, about 5 ppb, about 1 ppb, about 0.5 ppb, about 0.1 ppb, about 0.5 ppb, or any value or range between two of these values (including endpoints). In particular embodiments, the portions of the deseeded coffee cherry and/or the particulate composition may have a vomitoxin mycotoxin level of about 1 ppm, about 0.5 ppm, about 0.1 ppm, about 0.05 ppm, about 0.01 ppm, or any value or range between two of these values (including endpoints).

In various embodiments, the particulate composition may have a peak viscosity as measured by heating a paste at 90° C. in a Rapid Visco Analyzer. The paste may be formed from the particulate composition prepared in a slurry containing 5.5% particulate composition by dry weight. Alternatively, peak viscosity can be measured with the product at ambient room temperature in dry form without forming a slurry. The peak viscosity may be about 30 rapid visco units (RVU) to about 3000 rapid visco units or about 200 rapid visco units to about 500 rapid visco units, including about 30 rapid visco units, about 50 rapid visco units, about 100 rapid visco units, about 200 rapid visco units, about 500 rapid visco units, about 1000 rapid visco units, about 2000 rapid visco units, about 3000 rapid visco units, or any value or range between two of these values (including endpoints). Viscosity may affect the “mouth feel” of an ingested product, and its consumer appeal and acceptance. Additionally, viscosity can affect the ability of a product to blend with other materials to create a finished product.

In various embodiments, the particulate composition may absorb water. The amount of water absorbed by the particulate composition may be measured, for example, by placing a measured amount by weight of dry particulate composition in a container with a measured amount of water, and then incubating and stirring the mixture. Excess water is drained from the mixture and the moist precipitate is weighed. A water absorption index (WAI) can be calculated with the following equation:

$$WAI = \frac{mass of moist precipitate}{mass of dry particulate composition}$$

In some embodiments, the particulate composition may have a water absorption index of about 1 to about 20, including about 1, about 2, about 5, about 10, about 15, about 20, or any value or range between two of these values (including endpoints).

In various embodiments, a beverage composition may include at least one fluid and a solid composition, as described in greater detail herein. The fluid may be present in the beverage composition in an amount of about 50% by weight to about 85% by weight of the beverage composition, including about 50% by weight, about 55% by weight, about 60% by weight, about 65% by weight, about 70% by weight, about 75% by weight, about 80% by weight, about 85% by weight, or any value or range between two of these values (including endpoints). Correspondingly, the solid composition may be present in the beverage composition in an amount of about 15% by weight to about 50% by weight of the beverage composition, including about 15% by weight, about 20% by weight, about 25% by weight, about 30% by weight, about 35% by weight, about 40% by weight, about 45% by weight, about 50% by weight, or any value or range between two of these values (including endpoints). Thus, the mass ratio of solid composition to fluid in the beverage composition may be about 1:1 to about 1:20, including about 1:1, about 4:5, about 2:3, about 1:2, about 1:3, about 1:4, about 1:5, about 1:10, about 1:20, or any value or range between two of these values (including endpoints). The solid composition and the fluid may generally mixed together to form a homogenous beverage composition. For example, the solid composition may be suspended in the fluid to form the beverage composition.

In various embodiments, the solid composition may include at least the particulate composition. The particulate composition may be present in the solid composition in an amount of about 1% to about 70% by weight of the solid composition, about 2% to about 25% by weight of the solid composition, or about 20% to about 35% by weight of the solid composition, including about 1% by weight, about 2% by weight, about 5% by weight, about 10% by weight, about 15% by weight, about 20% by weight, about 25% by weight, about 30% by weight, about 35% by weight, about 40% by weight, about 45% by weight, about 50% by weight, about 55% by weight, about 60% by weight, about 65% by weight, about 70% by weight, or any value or range between two of these values (including endpoints).

In some embodiments, the beverage composition and/or the solid composition may further include any number of additional ingredients as described in greater detail herein, including an oil, a fat, a flour composition, a flavoring agent, a dairy product, a leavening agent, an enzyme, a starch, a gum, a reducing sugar, a sweetener, an electrolyte, an acidulant, a fruit juice, a fruit product, caffeine, and/or the like. In some embodiments, the solid composition may be a dry composition used in forming a beverage composition, as described in greater detail herein.

In some embodiments, the beverage composition may be caffeine-free or substantially caffeine-free. In various other embodiments, the beverage composition may include caffeine. In some embodiments, the caffeine may be naturally present in the beverage composition via one or more of the various ingredients, such as the deseeded coffee cherry. In other embodiments, the caffeine may be added to the beverage composition to enhance the caffeine concentration in the beverage composition. In some embodiments, the caffeine may be maintained and/or regulated by one or more of the following: maintaining extraction conditions of the particulate composition, such as temperature, residence time, and/or draw off factor; maintaining ultra-filtration conditions; and maintaining extract level conditions. The caffeine may be present in the beverage composition in an amount of about 0.01 milligrams per milliliter (mg/ml) of beverage composition to about 0.5 mg/ml, about 0.07 mg/ml to about 0.3 mg/ml, or about 0.15 mg/ml to about 0.3 mg/ml, including about 0.01 mg/ml, about 0.02 mg/ml, about 0.03 mg/ml, about 0.04 mg/ml, about 0.05 mg/ml, about 0.06 mg/ml, about 0.07 mg/ml, about 0.08 mg/ml, about 0.09 mg/ml, about 0.1 mg/ml, about 0.15 mg/ml, about 0.2 mg/ml, about 0.3 mg/ml, about 0.4 mg/ml, about 0.5 mg/ml, or any value or range between any two of these values (including endpoints).

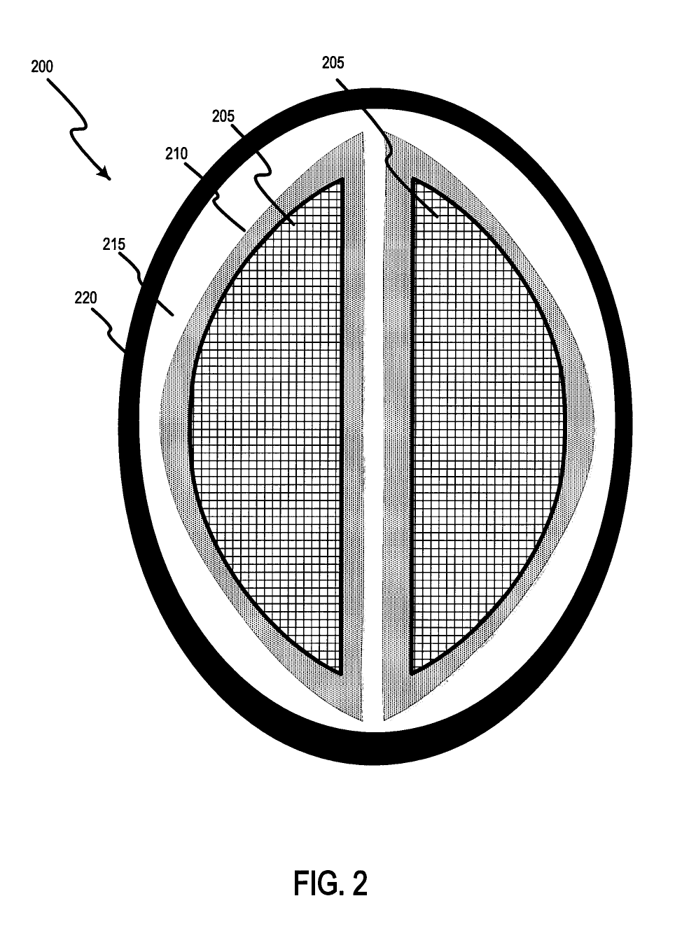

FIG. 2 depicts a second cross sectional view of a coffee cherry. As shown in FIG. 2, the coffee cherry 200 may include seeds 205 surrounded by a hull 210, a mucilage 215 and a pulp 220. The hull 210 may generally include the endocarp of the coffee cherry 200. The mucilage 215 may generally include the inner mesocarp of the coffee cherry 200. The pulp 220 may generally include at least a portion of the exocarp and the outer mesocarp of the coffee cherry 200.

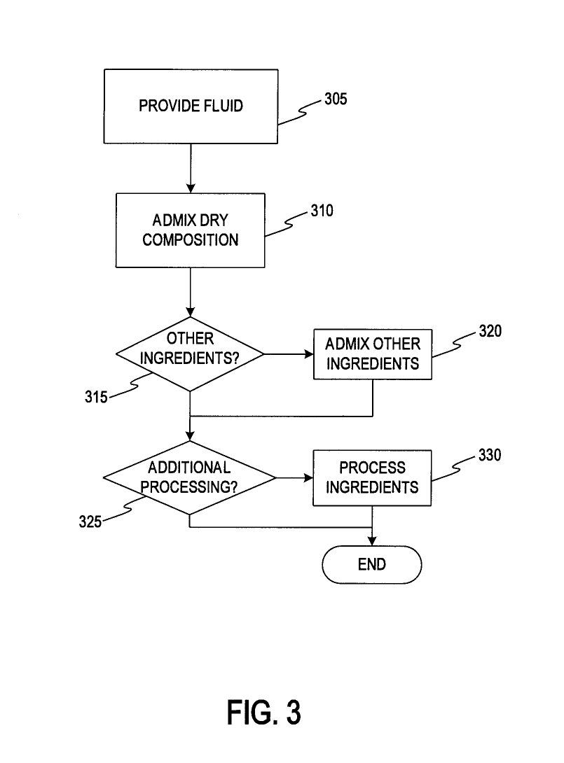

FIG. 3 depicts a flow diagram of a method of forming a beverage composition according to an embodiment. The method described in reference to FIG. 3 may generally be used in whole or in part and in varying order to form a beverage composition. In some embodiments, a fluid may be provided 305. The fluid may be any fluid that is safe for human or animal consumption, and is not limited by this disclosure. Illustrative examples of fluids may include juice, water, carbonated water, mineral water, electrolytic water, spring water, purified water, artesian water, filtered water, de-ionized water, distilled water, and/or the like. A juice, as used herein, may generally include any liquid obtained from fruits and/or vegetables, including extracts, concentrates, and/or the like. Carbonated water, as used herein, may generally refer to water that contains an amount of carbon dioxide therein. The carbonated water may be used to provide an effervescent beverage, as described herein. Mineral water may generally refer to water that is naturally or artificially impregnated with any number or combination of mineral salts, anions and cations. Electrolytic water may generally refer to water produced by the process of electrolysis, and may be characterized by an oxide reduction potential (ORP) and/or a pH that reflects its acid or alkaline nature. Spring water may generally refer to any pure drinking water that may or may not be of spring origin. Artesian water may generally refer to water that is obtained from an aquifer that is located below the surface of the earth. Filtered water may generally refer to any water that is passed through a filtration system to remove various ingredients, such as impurities and the like, from the water. De-ionized water may generally refer to water containing substantially no metal corrosive ions such as, for example, chlorine ions, sulfuric acid ions, and bicarbonate ions or scale forming ions such as, for example, calcium ions and magnesium ions. Distilled water may generally refer to any water that has been passed through a distillation process to remove various ingredients, such as impurities and the like, from the water. Other fluids include dairy milk, non-dairy milk, nut milks, rice milks, tea, coffee, kava, and other dried food extract fluids, and so on.

In various embodiments, the dry composition may be admixed 310 with the fluid. Admixing 310 the fluid and the dry composition may be completed by any method of combining, including, but not limited to, hand mixing, mixing with an electric handheld mixer, mixing with a stand mixer, mixing with a commercial mixing device, and/or the like. In some embodiments, the admixing 310 may be completed for a particular period of time, according to a particular method, and/or at a particular speed such that that the fluid and the dry composition are sufficiently blended. The fluid and the dry composition may be sufficiently blended if a random sample of the beverage composition contains a ratio of an amount by weight of the fluid to an amount by weight of the dry composition that corresponds to a desired ratio according to a particular recipe, as described in greater detail herein.

In some embodiments, the admixing 310 may also include admixing an extract with the fluid and the dry composition. The extract may generally be a preparation made from any part or parts of the deseeded coffee cherry and/or the particulate composition, as described in greater detail herein. The extract may generally be in a concentrated form and may include compounds that contribute to a characteristic flavor and/or aroma of the coffee cherry. Illustrative extracts may include, without limitation, pectin, essential oils, oleoresins, infusions, tinctures, and natural extractives, including distillates. The extract may not include crude plant parts, whether whole or ground. Some advantages of using an extract as described herein may include greater standardization and/or uniformity of a flavoring, lower cost, improved cost stability, greater ease of processing, and/or the like.

In various embodiments, a determination 315 may be made as to whether additional ingredients should be added to the combination of the fluid and the dry composition. The determination 315 may generally be based upon, for example, a desired type of food product, a desired flavor, a desired texture, a desired consistency, whether additional nutrients are needed, and/or the like. If the determination 315 is that additional ingredients should be added, the additional ingredients may be admixed 320 with the fluid and the dry composition. Illustrative additional ingredients may include an oil and/or a fat, a dairy product, a flavoring agent, an enzyme, flour, a starch, a gum, a reducing sugar, a sweetener, an electrolyte, an acidulant, a fruit juice, a fruit product, a coloring agent, a protein additive, and/or the like.

In some embodiments, the oil and/or the fat may be added to provide a desired texture and/or consistency, to add flavor, to provide a moist food product, and/or to act as a binder for the remaining ingredients in the food product. Specific examples of fats may include butter, margarine, shortening, lard, and/or the like. Specific examples of oils may include vegetable oil, castor oil, egg oil, rapeseed oil, soybean oil, corn oil, coconut oil, palm oil, safflower oil, sunflower seed oil, cottonseed oil, sesame oil, olive oil, camellia oil, rice oil, and/or the like.

In some embodiments, the dairy product may be added to provide a desired texture and/or consistency, to add flavor, to provide a moist food product, and/or to act as a binder for the remaining ingredients in the food product. Specific examples of dairy products may include butter, cheese, milk, buttermilk, condensed milk, powdered milk, whey, yogurt, cream, whipping cream, sour cream, and/or the like.

In various embodiments, the flavoring agent may generally provide the beverage composition with a preferred or a desired flavor, to lessen the impact of undesirable flavors caused by other ingredients, and/or the like. The flavoring agent is not limited by this disclosure, and may generally be any ingredient used to provide a flavor to the beverage composition. In some embodiments, the flavoring agent may include other ingredients described herein. In some embodiments, the flavoring agent may provide a savory flavor. Illustrative examples of flavoring agents may include, but are not limited to, barbecue, bacon, spices, herbs, dry vegetables such as onion, garlic, or tomato, dairy, peanut butter, nuts, seeds, vanilla, chocolate, and/or the like.

In various embodiments, the enzyme may aid in processing various starches used in the beverage composition. In some embodiments, the enzyme may improve the quality of the beverage composition so that it conforms to a desired taste and/or consistency. Specific examples of enzymes may include papain, bromelain, ficin, trypsin, chymotrypsin, and/or the like.

The flour may be any type of flour composition now known or later developed, particularly flour compositions suitable for human and/or animal consumption purposes. The flour composition may be made from cereal grains, seeds, beans nuts, roots, and/or the like. Specific examples of flour compositions may include tapioca flour, rice flour, oat flour, wheat flour, buckwheat flour, barley flour, rye flour, corn flour, bean flour, peanut flour, almond flour, chestnut flour, acorn flour, amaranth flour, hemp flour, sorghum flour, sweet potato flour, chickpea flour, quinoa flour, taro flour, arrowroot flour, coconut flour, potato flour, and the like, as well as mixtures thereof. In some embodiments, the flour composition, and by extension, the dry composition, may be substantially gluten free, thereby containing a gluten content of equal to or less than about 20 parts per million (ppm), including about 20 ppm, about 15 ppm, about 10 ppm, about 5 ppm, about 1 ppm, about 0.5 ppm, about 0.1 ppm, about 0.05 ppm, 0 ppm, or any value or range between two of these values (including endpoints).

In various embodiments, the starch may be used as a thickener and/or a stabilizer of the beverage composition. Specific examples of starches may include starch hydrolysate, hydroxyalkylated starch, starch ester, cross-linked starch, starch acetate, starch octenyl succinate, and/or the like.

In various embodiments, the gum may be added to provide a desired texture and/or consistency, to thicken the food product, and/or to stabilize the food product. Specific examples of gums may include guar gum, xanthan gum, gellan gum, carrageenan gum, gum Arabic, gum tragacanth, pectic acid, and/or the like. Gum Arabic is a natural food additive obtained from certain varieties of acacia. It is generally tasteless and odorless, and may be used in commercial food processing to thicken, emulsify, and/or stabilize foods. Guar gum is a gummy substance obtained from plants of the legume genera. Guar gum may also be used as a thickener and/or a stabilizer in commercial food processing. Xanthan gum is produced by fermentation of corn sugar, and may be used as a thickener, an emulsifier, and/or a stabilizer of foods.

In various embodiments, the reducing sugar may be used to provide desired texture, consistency, and color properties to the beverage composition. The reducing sugar may generally be any sugar that has an aldehyde group or any sugar that is capable of forming an aldehyde group via isomerism. Specific examples of reducing sugars may include maltose, lactose, dextrose and/or the like.

The sweetener may be in a solid, a semi-solid, or a liquid form, and may further be a caloric or a noncaloric sweetener. Specific examples of caloric sweeteners may include glucose, dextrose, fructose, lactose, sucrose, isomaltose, maltodextrin, corn syrup and the like, as well as mixtures thereof. Specific examples of noncaloric sweeteners may include acesulfame potassium, aspartame, neotame, saccharin, sucralose, and the like, as well as mixtures thereof.

In various embodiments, the electrolyte may be used as a dietary supplement to regulate nerve and muscle function, maintain acid-base balance, and maintain fluid balance in a body when consumed. Electrolytes such as chloride, potassium, sodium, magnesium, and calcium may be lost through sweat and may need to be replaced by consuming items containing the electrolyte.

In various embodiments, the acidulant may generally be used as a preservative of the beverage composition and such that the beverage composition has a pH that is suitable for human and/or animal consumption. In some embodiments, the acidulant may include an organic acid. In some embodiments, the acidulant may have a pKa of about 2 to about 7, including about 2, about 3, about 4, about 5, about 6, about 7, or any value or range between any two of these values (including endpoints). Thus, the pKa of the acidulant may be similar to that of a C2 or C3 fatty acid, which means that the acidulant may have, at least in its first dissociation stage, a stronger acidity than acetic acid, lactic acid, or propionic acid. Illustrative acidulants may include hydroxyl-containing carboxylic acids or di- or tricarboxylic acids which may additionally contain hydroxyl groups, and which contain from 3 to 6 carbon atoms. Specific examples of acidulants may include adipic acid, maleic acid, succinic acid, citric acid, fumaric acid, tartaric acid, lactic acid, ascorbic acid, and gluconic acid. The choice of a suitable acidulant may account for a strength of the acidulant by comparison with any fatty acid present in the beverage composition, a complexation capacity, flavoring, and/or any other effects which addition of the relevant acidulant may have on a particular beverage composition. In some embodiments, the acidulant may be an organic acid which is as mild as possible. Ascorbic acid is regarded herein as an acidulant although it may also be considered as an antioxidant or a vitamin.

In various embodiments, the fruit juice may be used to provide a desired flavor to the beverage composition. Fruit juice may generally be the juice of fleshy fruits, which are the ripened ovaries of flowers. Fruit juice also includes concentrates and extracts thereof. Illustrative examples of fruits from which fruit juice may be obtained include the fruit of deciduous trees such as apple, apricot, cherry, peach, pear, plum, nectarine, and persimmon; citrus fruits such as orange, lemon, lime, grapefruit, tangerine, pummelo, citron, papeda, tachibana, and kumquat; bushberry fruits such as blackberry, raspberry, dewberry, strawberry, blueberry, bilberry, cranberry, huckleberry, elderberry, currant, and gooseberry; berry fruits such as tomato, grape, banana (including plantain), and avocado; multiple fruits such as pineapple, mulberry, fig, and breadfruit; and gourd fruits such as watermelon, muskmelon, cantaloupe, cucumber, squash, pumpkin, and citron. In some embodiments, the fruit juice may be selected from any combination of fruits.

In various embodiments, the fruit product may be used to provide a flavor or a consistency to the beverage composition. The fruit product may generally be any product obtained by means of processing fruit, such as juice obtained by pressing fruit and pulp obtained by crushing or grinding fruit, including all liquids, rinds, inner skin, and/or the like.

The coloring agent may generally be any substance that is employed to produce a desired color, such as, for example, in a food or beverage. Such coloring agents are approved for human consumption pursuant to an appropriate governmental agency and/or act, such as, for example, the Food and Drug Administration (FDA)/Federal Food Drug and Cosmetic Act (FD&C) in the United States or the like. For example, the coloring agent may be a food-grade dye or a lake. A dye is a water soluble compound, which is available as a powder, granule, liquid, or other special purpose form. Dyes are typically used in beverages, dry mixes, baked goods, confections, dairy products, pet foods, and a variety of other products. A lake is a water-insoluble form of a dye. Typically, lakes are more stable than dyes and are ideal for coloring products containing fats and oils or items lacking sufficient moisture to dissolve dyes. Lakes are typically used in coated tablets, cake and donut mixes, hard candies, and chewing gums. Illustrative examples of coloring agents may include FD&C Blue No. 1 (Brilliant Blue), FD&C Blue No. 2 (Indigotine), FD&C Green No. 3 (Fast Green), FD&C Red No. 3 (Erythrosine), FD&C Red No. 40 (Allura Red), FD&C Yellow No. 5 (Tartrazine), FD&C Yellow No. 6 (Sunset Yellow), annatto extract, anthocyanis, aronia/redfruit, beet juice, beet powder, beta-carotene, beta-apo-8-carotenal, black currant, burnt sugar, canthaxanthin, caramel, carbo medicinalis, carmine, carmine/beta-carotene, carmine blue, carminic acid, carrot, carrot oils, chlorophyll, chlorophyllin, cochineal extract, copper-chlorophyll, copper-chlorophyllin, curcumin, curcumin/Cu-chlorophyllin, elderberry, grape, grape skin extracts, hibiscus, lutein, mixed carotenoids, paprika, paprika extract, paprika oleoresin, riboflavin, saffron, spinach, stinging nettle, titanium dioxide, turmeric, and combinations thereof.

In various embodiments, the protein additive may provide an additional protein source for the beverage composition. For example, in some beverage compositions, it may be desirable to obtain additional protein, such as beverage compositions that are consumed while exercising. The protein is not limited by this disclosure, and may include, for example, an egg and any portion thereof, a soybean, a green bean, a white bean, milk, an acorn, a chestnut, an almond, a peanut, a chickpea, a hazelnut, a coconut, and/or the like.

In various embodiments, the various ingredients described herein may be added to the dry composition and/or the particulate composition in the form of a pre-blended material. The pre-blended material is not limited by this disclosure and may include any type of pre-blended material, such as pre-packaged items and the like. For example, the various ingredients may be combined with the dry composition in the form of a dry drink mix and/or the like.

In various embodiments, a determination 325 may be made as to whether additional processing of the ingredients is necessary. If additional processing is necessary, the ingredients may be processed 330. Examples of additional processing may include, for example, sheeting, extruding, cutting, filing, folding, baking, boiling, frying, freezing, steaming, packaging and/or the like. The additional processing may generally be completed to cook the ingredients to obtain the beverage composition, to convert the ingredients into the beverage composition, to prepare the ingredients for shipping and delivery, to assist in that the ingredients comply with various safety standards, and/or the like.

In some embodiments, the ingredients may be processed 330 via pasteurization. Pasteurization is not limited by this disclosure, and may include any method of pasteurization or sterilization now known or later developed. In general, pasteurizing the ingredients may include exposing the ingredients to an elevated temperature for a period of time sufficient to destroy certain microorganisms and/or toxins, such as toxins produced by microorganisms. Illustrative microorganisms and/or toxins may include those that can produce disease or cause spoilage or undesirable fermentation of food. In some embodiments, the pasteurization may be completed without radically altering taste or quality. In some embodiments, the ingredients may be heated to a temperature of about 165° F. (73.9° C.) to about 240° F. (115.6° C.), including about 165° F. (73.9° C.), about 170° F. (76.7° C.), about 175° F. (79.4° C.), about 180° F. (82.2° C.), about 185° F. (85° C.), about 190° F. (87.8° C.), about 195° F. (90.6° C.), about 200° F. (93.3° C.), about 205° F. (96.1° C.), about 210° F. (98.9° C.), about 215° F. (101.7° C.), about 220° F. (104.4° C.), about 225° F. (107.2° C.), about 230° F. (110° C.), about 235° F. (112.8° C.), about 240° F. (115.6° C.), or any value or range between any two of these values (including endpoints). In a particular embodiment, the beverage composition may be pasteurized by heating the ingredients at about 239° F. (115° C.) for about 3 seconds to destroy the spores of the heat and acid resistant alcyclobacilli, which has been associated with non-pathogenic spoilage of ready-to-drink beverages.

In various embodiments, the beverage composition and/or components thereof may be monitored for quality. For example, a color and a clarity of the beverage composition may be measured using a spectrocolorimeter. The color of the beverage composition may be represented by the following parameters: L* for brightness on a scale of 0 to 100, where 0 is black and 100 is white; a* for a color on a red-green scale, where +a* is for red, −a* is for green, and the higher the numerical value, the more intensive the color impression; and b* for a color on a yellow-blue scale, where +b* is for yellow, −b* is for blue, and the higher the numerical value, the more intensive the color impression. A beverage composition sample may be illuminated under standardized conditions. The diffuse reflected light may be collected and obtained from spectral data, and the standard color values (X, Y, and Z) are calculated. The information may be transformed to the color parameters L*, a*, and b* according to the CIELAB system. Each series of samples may be placed into cuvettes that are washed with warm water and rinsed with deionized water. The class cuvette may have a quartz glass bottom with an inside diameter of about 6.1 cm. In some embodiments, a haze value may be determined within one hour of making the beverage composition. The haze value may be less than or equal to about 10 units or less than or equal to about 5 units, including about 10 units, about 9 units, about 8 units, about 7 units, about 6 units, about 5 units, about 4 units, about 3 units, about 2 units, about 1 unit, 0 units, or any value or range between any two of these values (including endpoints). Illustrative examples of acceptable color parameters of a beverage composition with a transmission path of a 10 mm cuvette may include L=85.51, a=1.87, b=29.39, and haze=2.16; L=88.62, a=0.49, b=24.4, and haze 4.06; and L=88.67, a=0.44, b=24.38, and haze=3.56.

### EXAMPLES

### Example 1

### Preparation of a Corn-Based Cereal Drink

Breakfast drinks, such as nutrient drinks, meal replacement drinks, diet drinks, and/or the like, have become increasingly popular for their ability to provide necessary nutrients and “on the go” portability. Thus, consumers have enjoyed the ability to consume a breakfast drink without having to sit down for a meal. A corn-based breakfast drink that incorporates a particulate composition as described herein may include the following ingredients:

| Ingredient | Grams | % by Weight |
|---|---|---|
| White Corn Flour | 330 | 66.0 |
| Particulate Composition | 120 | 24.0 |
| Cocoa Powder | 47 | 9.4 |
| Cinnamon | 1.6 | 0.32 |
| Clove | 0.7 | 0.14 |
| Pepper Allspice | 0.7 | 0.14 |

The ingredients are combined together in a stand mixer, measured for quality and consistency, and are packaged and pasteurized to remove any bacteria or harmful microorganisms. Liquids can be added in an amount to achieve a desired taste and consistency. For example, water, milk, fruit juice, vegetable juice, tea, coffee, or kava can be added. The amount of liquid can vary widely depending on the consumer taste and preference, such as from about 5% by weight to about 90% by weight. The resulting drink is expected to have a light brown color, milky in texture and a citrus-cherry-caramel flavor. Due to the antioxidant content of the deseeded coffee cherries in the particulate composition, the drink is expected to contain a high level of antioxidants. Accordingly, the deseeded coffee cherries, that were traditionally considered waste by coffee producers, were formed into beverage products.

### Example 2

### Preparation of a Barley-Based Cereal Drink

Another breakfast drink may be barley based. The barley-based breakfast drink may incorporate a particulate composition as described herein and may include the following ingredients:

| Ingredient | Grams | % by Weight |
|---|---|---|
| Milled Barley Grain | 178 | 35.6 |
| Particulate Composition | 90 | 18.0 |
| Refined Sugar | 225 | 45.0 |
| Cinnamon | 2.5 | 0.5 |
| Pepper Allspice | 1 | 0.2 |
| Calcium Propionate | 1.5 | 0.3 |
| Vanilla Powder | 2 | 0.4 |

The ingredients are combined together with a hand mixer and pasteurized to remove any bacteria or harmful microorganisms. The ingredients are later packaged into bulk containers for shipping, whereupon reaching a final destination, they are packaged into individual-sized containers. Liquids can be added in an amount to achieve a desired taste and consistency. For example, water, milk, fruit juice, vegetable juice, tea, coffee, or kava can be added. The amount of liquid can vary widely depending on the consumer taste and preference, such as from about 5% by weight to about 90% by weight. The resulting drink is expected to have a pale brown color, milky in texture and a citrus-cherry-caramel flavor. Due to the antioxidant content of the deseeded coffee cherries in the particulate composition, the drink is expected to contain a high level of antioxidants. Accordingly, the deseeded coffee cherries, that were traditionally considered waste by coffee producers, were formed into beverage products.

### Example 3

### Preparation of an Oat-Based Cereal Drink

A different breakfast drink may be oat based. The oat-based breakfast drink may incorporate a particulate composition as described herein and may include the following ingredients:

| Ingredient | Grams | % by Weight |
|---|---|---|
| Milled Rolled Oats | 140 | 28.0 |
| Particulate Composition | 80 | 16.0 |
| Refined Sugar | 276 | 55.2 |
| Cinnamon | 2.5 | 0.5 |
| Calcium Propionate | 1.5 | 0.3 |

The ingredients are combined together in a stand mixer and mixed until well blended. The resultant beverage composition is pasteurized at 200° F. (93° C.) for 5 minutes to kill all harmful microorganisms and packaged into individual sized portions. Liquids can be added in an amount to achieve a desired taste and consistency. For example, water, milk, fruit juice, vegetable juice, tea, coffee, or kava can be added. The amount of liquid can vary widely depending on the consumer taste and preference, such as from about 5% by weight to about 90% by weight. The resulting drink is expected to have a medium brown color, milky in texture and a citrus-cherry-caramel flavor. Due to the antioxidant content of the deseeded coffee cherries in the particulate composition, the drink is expected to contain a high level of antioxidants. Accordingly, the deseeded coffee cherries, that were traditionally considered waste by coffee producers, were formed into beverage products.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera As a non-limiting example, each range discussed herein can be readily broken down into a lower third, middle third and upper third, et cetera As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A beverage composition comprising:
at least one fluid;
a solid composition admixed with the fluid, wherein the solid composition comprises a particulate composition comprising one or more portions of a dried deseeded coffee cherry, and wherein the particulate composition has an average particle size of about 0.1 μm to about 3000 μm.

2. The beverage composition of claim 1, wherein the one or more portions of the dried deseeded coffee cherry comprises one or more of a hull, a mucilage, a silverskin, a parchment coat, a pectin layer, a pulp, and an outer skin.

3. The beverage composition of claim 1, wherein the particulate composition consists of the deseeded coffee cherry.

4. The beverage composition of claim 1, wherein the one or more portions of the dried deseeded coffee cherry consists of one or more of a pulp, a mucilage, and a hull.

5. The beverage composition of claim 1, wherein the particulate composition has an average particle size of about 120 μm to about 200 μm.

6. The beverage composition of claim 1, wherein the particulate composition is present in the solid composition in an amount of about 1% to about 70% by weight of the solid composition.

7.-8. (canceled)

9. The beverage composition of claim 1, wherein the solid composition further comprises one or more of tapioca flour, rice flour, oat flour, wheat flour, buckwheat flour, barley flour, rye flour, corn flour, bean flour, peanut flour, almond flour, chestnut flour, acorn flour, amaranth flour, hemp flour, sorghum flour, sweet potato flour, chickpea flour, quinoa flour, taro flour, arrowroot flour, coconut flour, and potato flour.

10. The beverage composition of claim 1, wherein the solid composition has a peak viscosity of about 30 rapid visco units to about 3000 rapid visco units.

11. (canceled)

12. The beverage composition of claim 1, wherein the solid composition is present in the beverage composition in an amount of about 15% by weight to about 50% by weight of the beverage composition.

13. The beverage composition of claim 1, wherein the solid composition has a water absorption index of about 1 to about 20.

14. The beverage composition of claim 1, wherein the beverage composition has a mass ratio of the solid composition to the fluid of about 1:1 to about 1:20.

15. The beverage composition of claim 1, wherein the solid composition is suspended in the fluid.

16. The beverage composition of claim 1, further comprising at least one of:
an oil;
a fat;
at least one dairy product;
at least one flavoring agent;
at least one enzyme;
at least one starch comprising starch hydrolyzate, hydroxyalkylated starch, starch ester, cross-linked starch, starch acetate, or starch octenyl succinate;
at least one gum comprising guar gum, xanthan gum, gellan gum, carrageenan gum, gum Arabic, gum tragacanth, or pectic acid;
at least one reducing sugar comprising maltose, lactose, or dextrose;
at least one sweetener comprising glucose, fructose, lactose, sucrose, isomaltose, maltodextrin, or corn syrup;
at least one electrolyte;
at least one acidulant;
at least one fruit juice;
at least one fruit product;
at least one coloring agent; and
at least one protein additive comprising egg, a soybean, a green bean, a white bean, milk, an acorn, a chestnut, an almond, a peanut, a chickpea, a hazelnut, or a coconut.

17.-27. (canceled)

28. The beverage composition of claim 1, further comprising caffeine.

29. The beverage composition of claim 28, wherein the caffeine is present in the beverage composition at a concentration of about 0.01 milligrams per milliliter to about 0.5 milligrams per milliliter.

30.-31. (canceled)

32. The beverage composition of claim 1, wherein the beverage composition is a carbonated soft drink, a non-carbonated soft drink, a fountain beverage, a frozen beverage, a ready-to-drink beverage, a dairy beverage, a powdered soft drink, a liquid concentrate, a liquid extract, a liquid dessert, a nutritional supplement, a flavored water, an enhanced water, an energy drink, a breakfast drink, a sport drink, or an alcoholic drink.

33. The beverage composition of claim 1, wherein the fluid comprises one or more of a juice, water, carbonated water, mineral water, electrolytic water, spring water, purified water, artesian water, filtered water, de-ionized water, and distilled water.

34.-35. (canceled)

36. A method of forming a beverage composition, the method comprising:
providing at least one fluid; and
admixing a dry composition with the fluid, wherein the dry composition comprises a particulate composition comprising one or more portions of a dried deseeded coffee cherry, and wherein the particulate composition has an average particle size of about 0.1 μm to about 3000 μm.

37. The method of claim 36, wherein the one or more portions of the dried deseeded coffee cherry comprises one or more of a pulp, a mucilage, and a hull.

38. The method of claim 36, wherein the particulate composition consists of the deseeded coffee cherry.

39. The method of claim 36, wherein the one or more portions of the dried deseeded coffee cherry consists of one or more of a pulp, a mucilage, and a hull.

40. The method of claim 36, wherein the admixing further comprises admixing an extract with the fluid and the dry composition, wherein the extract is derived from the particulate composition.

41. The method of claim 36, further comprising admixing at least one of the following with the dry composition and the fluid:
an oil;
a fat;
at least one dairy product;
at least one flavoring agent;
at least one enzyme;
at least one flour, wherein the flour comprises tapioca flour, rice flour, oat flour, wheat flour, buckwheat flour, barley flour, rye flour, corn flour, bean flour, peanut flour, almond flour, chestnut flour, acorn flour, amaranth flour, hemp flour, sorghum flour, sweet potato flour, chickpea flour, quinoa flour, taro flour, arrowroot flour, coconut flour, or potato flour;
at least one starch, wherein the starch comprises starch hydrolyzate, hydroxyalkylated starch, starch ester, cross-linked starch, starch acetate, or starch octenyl succinate;
at least one gum, wherein the gum comprises guar gum, xanthan gum, gellan gum, carrageenan gum, gum Arabic, gum tragacanth, or pectic acid;
at least one reducing sugar, wherein the reducing sugar comprises maltose, lactose, or dextrose;
at least one sweetener, wherein the sweetener comprises glucose, fructose, lactose, sucrose, isomaltose, maltodextrin, or corn syrup;
at least one electrolyte;
at least one acidulant;
at least one fruit juice;
at least one fruit product;
at least one coloring agent; and
at least one protein additive, wherein the protein additive comprises an egg, a soybean, a green bean, a white bean, milk, an acorn, a chestnut, an almond, a peanut, a chickpea, a hazelnut, or a coconut.

42.-55. (canceled)

56. The method of claim 36, further comprising:
pasteurizing a mixture of the dry composition and the fluid.

57. The method of claim 36, wherein the fluid comprises at least one of a juice, water, carbonated water, mineral water, electrolytic water, spring water, purified water, artesian water, filtered water, de-ionized water, and distilled water.
